(19) United States
(12) Patent Application Publication
(10) Pub. No.: US 2010/0323113 A1
(43) Pub. Date: Dec. 23, 2010

(54) Method to Synthesize Graphene

(76) Inventors: Deepak A. Ramappa, Cambridge, MA (US); Paul Sullivan, Wenham, MA (US)

Correspondence Address: Nields, Lemack & Frame, LLC, 176 E. MAIN STREET, SUITE 5, WESTBOROUGH, MA, 01581, US

(21) Appl. No.: 12/487,100

(22) Filed: Jun. 18, 2009

(51) Int. Cl. B05D 3/00

(52) U.S. Cl. 427/398.1

(57) ABSTRACT

A method of using ion implantation techniques to create graphene is disclosed. Carbon ions are implanted in a substrate, such as a metal foil, using a plasma doping system or a beam line implanter. The implant is performed at an elevated temperature, to allow a large number of carbon ions to be absorbed by the foil. As the temperature is reduced, the excessive number of carbon atoms causes the foil to be saturated, and the carbon atoms diffuse to the surface, thereby producing graphene. In another embodiment, a plasma doping system is used, where a plasma containing carbon and other species is created. These additional species are also implanted, thereby causing the diffused atoms to contain both carbon and the additional species.

### BACKGROUND OF THE INVENTION

Graphene has recently increased in importance due to its potential applicability for a variety of electronic uses. It has good diffusion barrier properties, making it corrosion resistant. Graphene has good antireflection property with low resistance, allowing it to be used for solar cells. It also has high carrier mobility, allowing it to be used to create transistor channels. Furthermore, it has an acute response to stress, making it suitable for sensor applications. Graphene's high conductivity and high optical transparency make it an excellent material for such applications as touch screens, and liquid crystal displays. Due to its high surface area to mass ration, graphene may also be used to create ultracapacitors.

Graphene is a monolayer of carbon atoms arranged in a hexagonal shape, as shown in FIG. 1. Each carbon atom is bonded to three adjacent atoms via sp² bonding. Graphene synthesis has been achieved on a laboratory scale. One of the first successful attempts to create graphene was done in 2004 by extracting a single layer of carbon from a bulk piece of graphite. Since that time, others have reported creation of small graphene layers through the use of chemical vapor deposition (CVD), typically on nickel substrates.

The main obstacle presenting the use of graphene in the aforementioned commercial applications is the ability to produce it on a large scale. The creation of large-scale patterns of graphene may be enhanced through the use of an ion implantation technology. Ion implanters are commonly used in the production of semiconductor wafers. An ion source is used to create a beam of charged ions, which is then directed toward the wafer. As the ions strike the wafer, they impart a charge in the area of impact. This charge allows that particular region of the wafer to be properly “doped”.

FIG. 2 is a block diagram of a plasma doping system 100, while FIG. 3 is a block diagram of a beam-line ion implanter 200. Those skilled in the art will recognize that the plasma doping system 100 and the beam-line ion implanter 200 are each only one of many examples of differing plasma doping systems and beam-line ion implanters that can provide ions. This process also may be performed with other ion implantation systems or other substrate or semiconductor wafer processing equipment. While a silicon substrate is discussed in many embodiments, this process also may be applied to substrates composed of SiC, GaN, GaP, GaAs, polysilicon, Ge, quartz, or other materials known to those skilled in the art.

Turning to FIG. 2, the plasma doping system 100 includes a process chamber 102 defining an enclosed volume 103. A platen 134 may be positioned in the process chamber 102 to support a substrate 138. In one instance, the substrate 138 may be a semiconductor wafer having a disk shape, such as, in one embodiment, a 300 millimeter (mm) diameter silicon wafer. In other embodiments, the substrate may be metal foil. The substrate 138 may be clamped to a flat surface of the platen 134 by electrostatic or mechanical forces. In one embodiment, the platen 134 may include conductive pins (not shown) for making connection to the substrate 138.

A gas source 104 provides a dopant gas to the interior volume 103 of the process chamber 102 through the mass flow controller 106. A gas baffle 170 is positioned in the process chamber 102 to deflect the flow of gas from the gas source 104. A pressure gauge 108 measures the pressure inside the process chamber 102. A vacuum pump 112 evacuates exhausts from the process chamber 102 through an exhaust port 110 in the process chamber 102. An exhaust valve 114 controls the exhaust conductance through the exhaust port 110.

The plasma doping system 100 may further include a gas pressure controller 116 that is electrically connected to the mass flow controller 106, the pressure gauge 108, and the exhaust valve 114. The gas pressure controller 116 may be configured to maintain a desired pressure in the process chamber 102 by controlling either the exhaust conductance with the exhaust valve 114 or a process gas flow rate with the mass flow controller 106 in a feedback loop that is responsive to the pressure gauge 108.

The process chamber 102 may have a chamber top 118 that includes a first section 120 formed of a dielectric material that extends in a generally horizontal direction. The chamber top 118 also includes a second section 122 formed of a dielectric material that extends a height from the first section 120 in a generally vertical direction. The chamber top 118 further includes a lid 124 formed of an electrically and thermally conductive material that extends across the second section 122 in a horizontal direction.

The plasma doping system may further include a source 101 configured to generate a plasma 140 within the process chamber 102. The source 101 may include a RF source 150, such as a power supply, to supply RF power to either one or both of the planar antenna 126 and the helical antenna 146 to generate the plasma 140. The RF source 150 may be coupled to the antennas 126, 146 by an impedance matching network 152 that matches the output impedance of the RF source 150 to the impedance of the RF antennas 126, 146 in order to maximize the power transferred from the RF source 150 to the RF antennas 126, 146.

The plasma doping system 100 also may include a bias power supply 148 electrically coupled to the platen 134. The bias power supply 148 is configured to provide a pulsed platen signal having pulse on and off time periods to bias the platen 134, and, hence, the substrate 138, and to accelerate ions from the plasma 140 toward the substrate 138 during the pulse on time periods and not during the pulse off periods. The bias power supply 148 may be a DC or an RF power supply.

The plasma doping system 100 may further include a shield ring 194 disposed around the platen 134. As is known in the art, the shield ring 194 may be biased to improve the uniformity of implanted ion distribution near the edge of the substrate 138. One or more Faraday sensors such as an annular Faraday sensor 199 may be positioned in the shield ring 194 to sense ion beam current.

The plasma doping system 100 may further include a controller 156 and a user interface system 158. The controller 156 can be or include a general-purpose computer or network of general-purpose computers that may be programmed to perform desired input/output functions. The controller 156 can also include other electronic circuitry or components, such as application-specific integrated circuits, other hardwired or programmable electronic devices, discrete element circuits, etc. The controller 156 also may include communication devices, data storage devices, and software. For clarity of illustration, the controller 156 is illustrated as providing only an output signal to the power supplies 148, 150, and receiving input signals from the Faraday sensor 199. Those skilled in the art will recognize that the controller 156 may provide output signals to other components of the plasma doping system and receive input signals from the same. The user interface system 158 may include devices such as touch screens, keyboards, user pointing devices, displays, printers, etc. to allow a user to input commands and/or data and/or to monitor the plasma doping system via the controller 156.

In operation, the gas source 104 supplies a primary dopant gas containing a desired dopant for implantation into the substrate 138. The gas pressure controller 116 regulates the rate at which the primary dopant gas is supplied to the process chamber 102. The source 101 is configured to generate the plasma 140 within the process chamber 102. The source 101 may be controlled by the controller 156. To generate the plasma 140, the RF source 150 resonates RF currents in at least one of the RF antennas 126, 146 to produce an oscillating magnetic field. The oscillating magnetic field induces RF currents into the process chamber 102. The RF currents in the process chamber 102 excite and ionize the primary dopant gas to generate the plasma 140.

The bias power supply 148 provides a pulsed platen signal to bias the platen 134 and, hence, the substrate 138 to accelerate ions from the plasma 140 toward the substrate 138 during the pulse on periods of the pulsed platen signal. The frequency of the pulsed platen signal and/or the duty cycle of the pulses may be selected to provide a desired dose rate. The amplitude of the pulsed platen signal may be selected to provide a desired energy. With all other parameters being equal, a greater energy will result in a greater implanted depth. The plasma doping system 100 may incorporate hot or cold implantation of ions in some embodiments.

Turning to FIG. 3, a beam-line ion implanter 200 may produce ions for treating a selected substrate. In one instance, this may be for doping a semiconductor wafer. In another embodiment, this may be for doping a metal foil. In general, the beam-line ion implanter 200 includes an ion source 280 to generate ions that form an ion beam 281. The ion source 280 may include an ion chamber 283 and a gas box containing a gas to be ionized. The gas is supplied to the ion chamber 283 where the gas is ionized. This gas may be or may include or contain, in some embodiments, hydrogen, helium, other rare gases, oxygen, nitrogen, arsenic, boron, phosphorus, carborane, alkanes, or another large molecular compound. The ions thus generated are extracted from the ion chamber 283 to form the ion beam 281. A power supply is connected to an extraction electrode of the ion source 280 and provides an adjustable voltage.

The ion beam 281 passes through a suppression electrode 284 and ground electrode 285 to mass analyzer 286. Mass analyzer 286 includes resolving magnet 282 and masking electrode 288 having resolving aperture 289. Resolving magnet 282 deflects ions in the ion beam 281 such that ions of a desired ion species pass through the resolving aperture 289. Undesired ion species do not pass through the resolving aperture 289, but are blocked by the masking electrode 288.

Ions of the desired ion species pass through the resolving aperture 289 to the angle corrector magnet 294. Angle corrector magnet 294 deflects ions of the desired ion species and converts the ion beam from a diverging ion beam to ribbon ion beam 212, which has substantially parallel ion trajectories. The beam-line ion implanter 200 may further include acceleration or deceleration units in some embodiments.

An end station 211 supports one or more substrates, such as substrate 138, in the path of ribbon ion beam 212 such that ions of the desired species are implanted into substrate 138. The substrate 138 may be, for example, a silicon wafer or a solar panel. The end station 211 may include a platen 295 to support the substrate 138. The end station 211 also may include a scanner (not shown) for moving the substrate 138 perpendicular to the long dimension of the ribbon ion beam 212 cross-section, thereby distributing ions over the entire surface of substrate 138. Although the ribbon ion beam 212 is illustrated, other embodiments may provide a spot beam.

The ion implanter 200 may include additional components known to those skilled in the art. For example, the end station 211 typically includes automated substrate handling equipment for introducing substrates into the beam-line ion implanter 200 and for removing substrates after ion implantation. The end station 211 also may include a dose measuring system, an electron flood gun, or other known components. It will be understood to those skilled in the art that the entire path traversed by the ion beam is evacuated during ion implantation. The beam-line ion implanter 200 may incorporate hot or cold implantation of ions in some embodiments.

As stated above, ion implantation is a standard technique for introducing conductivity-altering impurities into semiconductor substrates. A desired impurity material is ionized in an ion source, the ions are accelerated, and the ions are directed at the surface of the substrate. The energetic ions penetrate into the bulk of the material. Following an annealing process, the ions may become incorporated into the crystalline lattice of the semiconductor material to form a region of desired conductivity.

An efficient, large scale graphene synthesis method is of immense interest to the electronic material industry. Accordingly, it would be beneficial if these proven ion implantation processes could be used to implant carbon atoms into a substrate, which then diffuse to form layers of graphene. It would also be beneficial if additional dopants can also be implanted simultaneously so as to form graphene-based compounds, such as graphane.

### SUMMARY OF THE INVENTION

The problems of the prior art are addressed by the present disclosure, which describes a method of using ion implantation techniques to create graphene. Carbon ions are implanted in a substrate, such as a metal foil, using a plasma doping system or a beam line implanter. The implant is performed at an elevated temperature, to allow a large number of carbon ions to be absorbed by the foil. As the temperature is reduced, the excessive number of carbon atoms causes the foil to be saturated, and the carbon atoms diffuse to the surface, thereby producing graphene. In another embodiment, a plasma doping system is used, where a plasma containing carbon and other species is created. These additional species are also implanted, thereby causing the diffused atoms to contain both carbon and the additional species.

### BRIEF DESCRIPTION OF THE DRAWINGS

For a better understanding of the present disclosure, reference is made to the accompanying drawings, in which like elements are referenced with like numerals, and in which:

FIG. 1 is a diagram showing the structure of graphene;

FIG. 2 is a block diagram of a plasma doping system;

FIG. 3 is a block diagram of a beam-line ion implanter;

FIG. 4 is a sequence showing the deposition of carbon into a metal foil and the subsequent creation of graphene;

FIG. 5 is a sequence showing the deposition of carbon into a metal foil when applied in the presence of a mark and the subsequent selective creation of graphene; and

FIG. 6 is a sequence showing the cleaving process for a substrate.

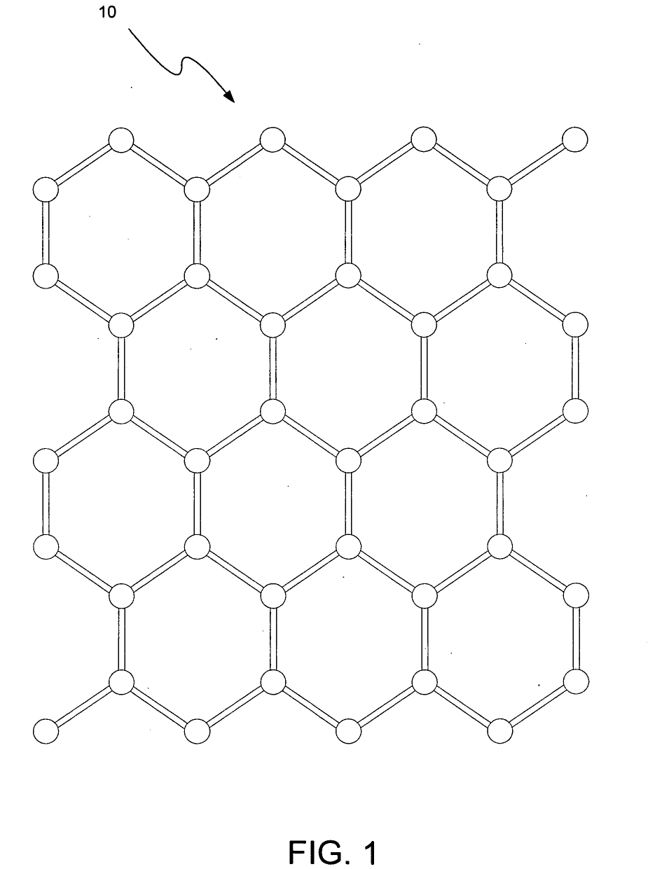

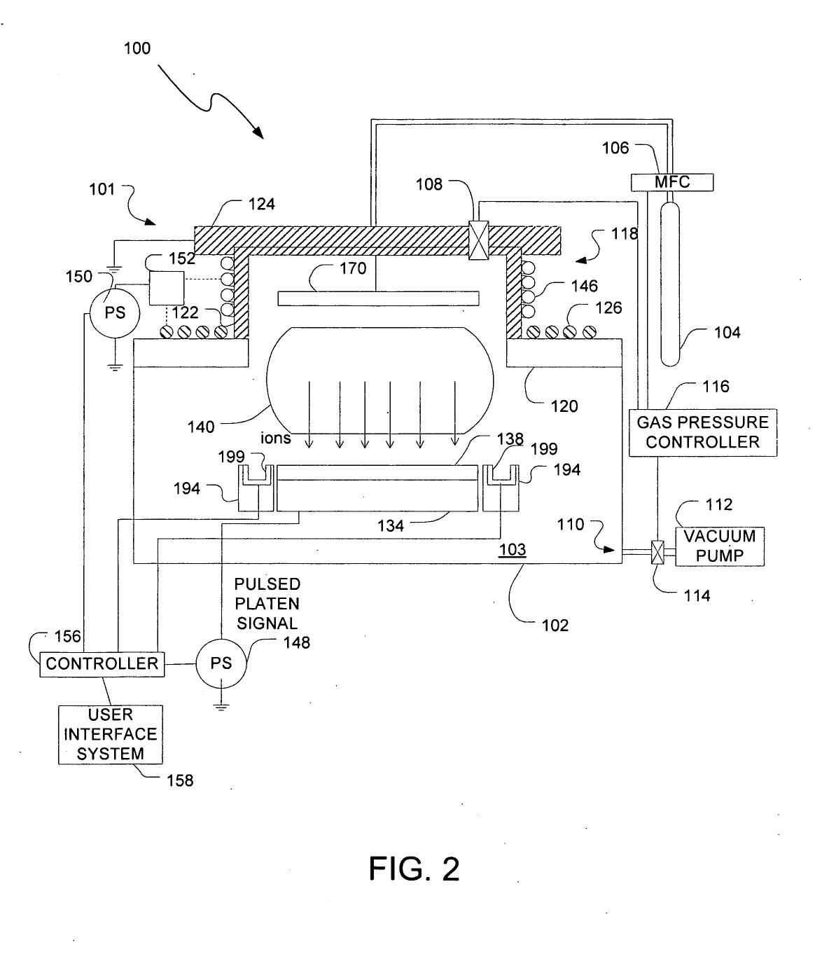

### DETAILED DESCRIPTION OF THE INVENTION

As stated above, ion implantation is used to deposit ions into a substrate. In many applications, the substrate is a semiconductor material, such as silicon, however this is not a requirement.

In the present disclosure, the substrate may be a metal or metal foil, such as but not limited to copper, nickel, ruthenium, iron and aluminum. In addition, the substrate can comprise alloys such as but not limited to bronze, brass, and invar, may also be used.

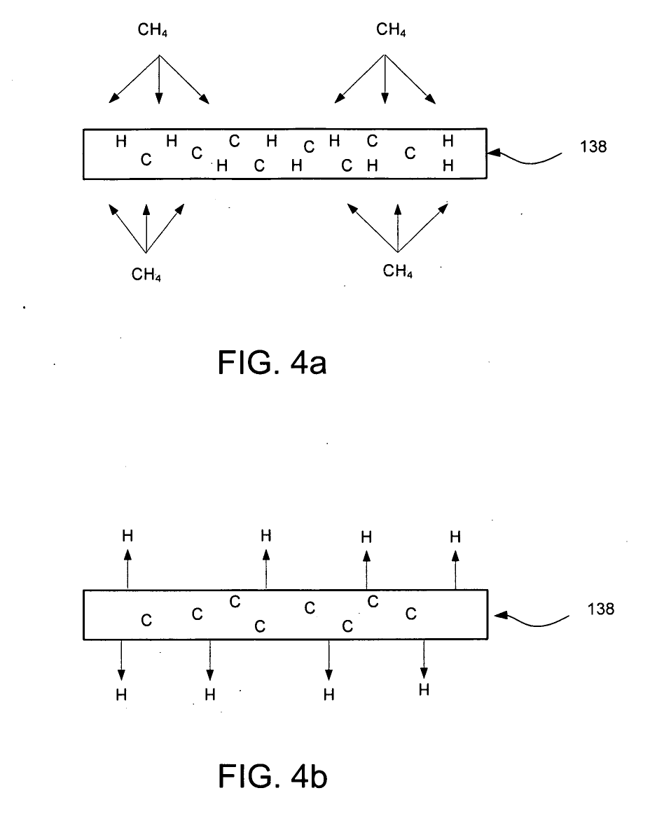

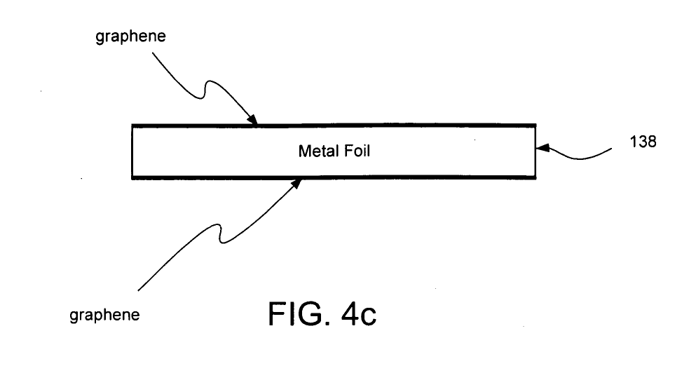

In one embodiment, carbon ions, in the form of methane gas (CH₄) are implanted into the substrate. Other hydrocarbons, such as ethane, propane and others can also be used. The substrate is maintained at an elevated temperature, such as 200° C. to 600° C. or above. This increased temperature increases the solubility limits of carbon in the substrate. FIG. 4a shows a representative substrate being implanted with methane. At elevated temperatures, hydrogen tends to quickly diffuse to the surface, and into the environment, thereby leaving only carbon atoms implanted in the substrate, as shown in FIG. 4b. After the desired amount of atoms has been implanted, the temperature of the substrate is lowered, thereby causing the carbon atoms to precipitate to the surface, as shown in FIG. 4c.

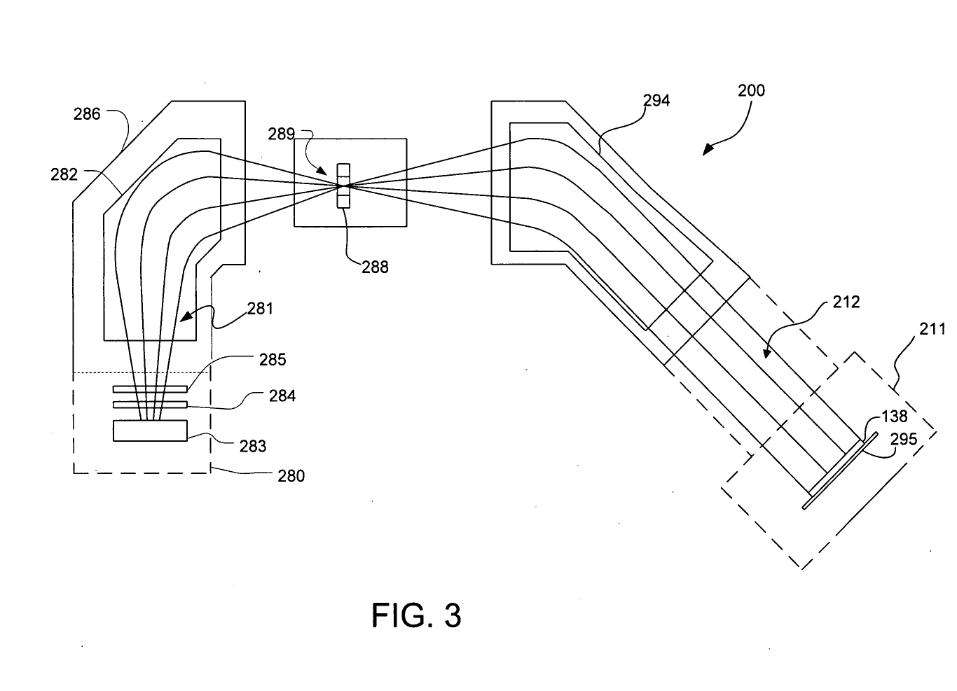

The implant of methane can be performed using a beam line implanter, as shown in FIG. 3, or a plasma doping system, as shown in FIG. 2. In one embodiment, the substrate is a metal foil, approximately xxx in thickness. The methane being implanted in the metal foil has a specific energy level, which is used to control the depth of the implantation of the carbon atoms within the substrate. In one embodiment, energy levels of between xxx and xxx are used. In addition, the dose of methane used can be varied as well. The dose that the substrate can absorb is dependent on its ambient temperature. Thus, at higher temperatures, more carbon can be introduced into the substrate. Typical doses of carbon atoms may be in the range of 1E15 to 1E17, at temperatures between 200° and 600° C.

Variations in the dosages and energy level may affect the dopant profile of the carbon within the substrate. These changes in the profile can be used to accelerate or decelerate the precipitation of carbon out of the substrate. For example, a high dose of ions, implanted at a lower energy level will cause a large number of carbon atoms to be implanted just below the surface of the substrate. This amount can be further increased by further elevating the temperature of the substrate. As the temperature of the substrate is reduced, these carbon atoms will diffuse quickly from the substrate. In contrast, a higher implant energy will cause the carbon to be distributed deeper within the substrate, thereby slowing the time to diffuse to the surface.

Furthermore, the creation and structure of the graphene layers can be tuned by varying the temperature profile during cooling. For example, graphene growth has shown a dependence on the metal substrate crystal orientation. For example, the temperature can be instantaneously decreased, or decreased more slowly at a constant rate. These changes will affect the thickness of the graphene and its growth orientation.

The use of implantation technology allows for precise control of the carbon concentration and depth. This control allows for finer control of the graphene growth, as the diffusion rate and precipitation can be more tightly controlled. Furthermore, the use of implantation technology, such as beam line implanters and plasma doping systems allows for a variety of dopant profiles. For example, retrograde profiles, surface peak profiles, multiple peak profiles can all be achieved. Each of these may be advantageous in the precipitation of carbon and the creation of graphene.

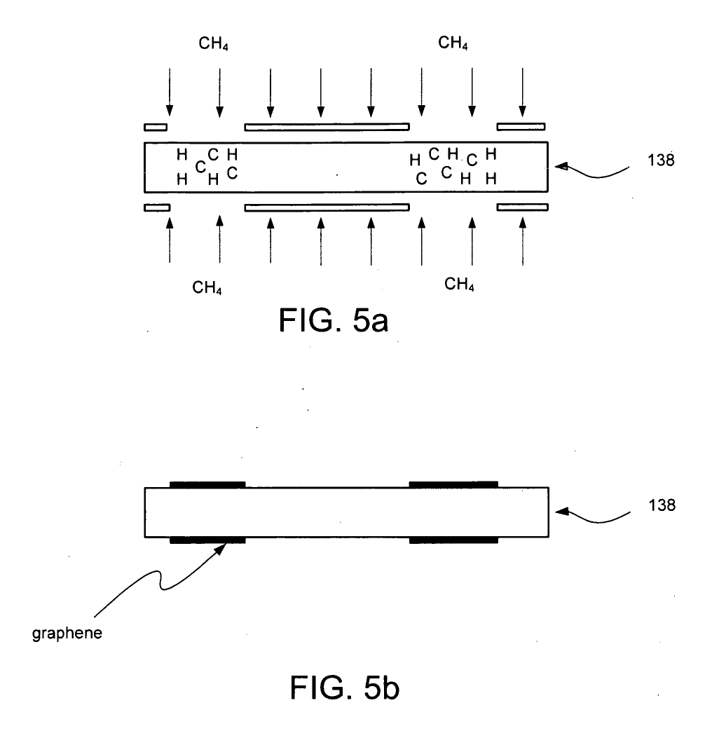

Additionally, implantation is commonly used to create doping patterns within a substrate. One such technique is to use a mask to block a portion of the substrate from being exposed to the incoming ions. This technique can also be used to create a specific pattern or shape. For example, as shown in FIG. 5a, a mask can be placed over a portion of the metal foil. The carbon atoms can then be implanted in the exposed portion of the foil. Those portions of the substrate that are shielded by the mask are not implanted. As the temperature is reduced, carbon will precipitate from those portions that were exposed, thereby creating a specific shape or pattern of graphene layers. FIG. 5b shows a cross-sectional view of the graphene layers produced over in those areas that were implanted. The shape and size of the pattern can be varied as desired.

Since the carbon atoms are being implanted into the substrate, this technique allows the use of lower temperatures than can be used in other methods, such as CVD. Lower temperatures may be advantageous, as the substrate's grain growth is accelerated at high temperatures, which impacts the creation of graphene.

Some of graphene's unique properties result from its atomic structure. In its natural state, there are unbonded electrons at each carbon atom. These unbonded electrons may be bonded to another species to create other useful compounds. Some examples may include graphane, where a hydrogen atom is attached to each carbon atom. Other examples include graphene oxide, where an oxygen atom is attached to each carbon atom. Other compounds may include a halogenized form of graphene.

Ion implantation also allows the use of ions that contains many species. For example, as described above, methane is used to supply carbon and hydrogen atoms to the substrate. At elevated temperatures, the hydrogen quickly diffuses out of the substrate. However, at lower temperatures, the hydrogen may bond with these unbonded electrons in the carbon atoms to create graphane.

In another embodiment, oxygen, in the form of xxx, is doped with carbon. This allows the oxygen atoms to attach to the unbonded carbon electrons, yielding graphene oxide.

In another embodiment, a halogen, such as fluorine, chlorine, bromine, or iodine, is implanted with carbon to create biocompatible phases of graphene. For example, carbon tetrachloride (CCl₄) may be used as a source gas. Oxygen and nitrogen may also have the potential to create biocompatible phases of graphene. These altered graphene films could then be used as a passivating layer over implantable devices.

These multiple species can be implanted in a number of ways. In one embodiment, the species are implanted sequentially. In one words, the methane may be implanted in the substrate first, followed by the additional species. In another embodiment, this order of implantation is reversed. In the case of a sequential implant, the source is simply changed during the implantation process. This can be done using either a plasma doping or beam line implanter.

In a third embodiment, the carbon and the additional species are simultaneously implanted. In the case of a plasma doping system, the various sources are all combined in the chamber and turned into a plasma. This plasma will contain ions from all of the source gases. In the case of a beamline system, this may be accomplished by eliminating the mass analyzer and allowing all ions to pass from the implanter to the substrate.

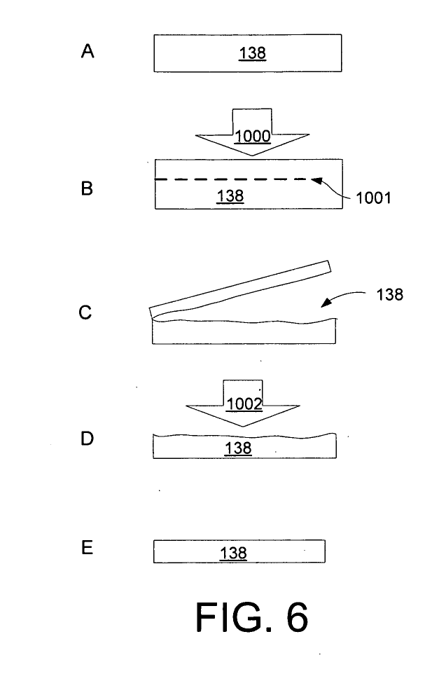

In another embodiment, additional species are implanted to help separate or cleave the graphene from the substrate. There are several methods of performing a cleave process, such as one referred to as “SmartCut”, which is shown in FIG. 6. This process is used for many applications, including the preparation of silicon-on-insulator (SOI). Briefly, a semiconductor substrate, such as a wafer 138, receives a surface treatment to oxide the surface. This creates an insulating layer around the substrate. An ion implantation of hydrogen and/or helium 1000 is then applied to the substrate 138, as shown in FIG. 6b. The implanted hydrogen or helium ions tend to cause bubbles while the substrate is being annealed. These bubbles may aggregate to form a layer 1001 within the substrate. The depth of this layer is dependent on the concentration and energy of the hydrogen ions, as well as the anneal time. This layer weakens the substrate at that position, allowing it to be cleaved, as shown in FIG. 6c. Either side of the cleaved substrate can be implanted with a second species, if desired, as shown in FIG. 6d. This cleaved interface is then smoothed, using techniques such as chemical-mechanical polishing (CMP). The resulting film and handle substrate is then suitable for use in a SOI process. The remainder of the original semiconductor wafer can be reused to create another thin film, as shown in FIG. 6e.

By introducing helium or hydrogen with, or after, the implantation of carbon, it may be possible to cleave layers of graphene from the substrate as they are formed.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of creating layers of graphene, comprising:
Implanting carbon atoms into a substrate at a first temperature; and
Lowering the temperature of said substrate following said implanting step, so that said carbon atoms diffuse from said substrate.

2. The method of claim 1, wherein said implanting step is performed using a plasma doping system.

3. The method of claim 1, wherein said implanting step is performed using a beam line implanter.

4. The method of claim 1, further comprising using methane to create said carbon atoms to be implanted.

5. The method of claim 1, wherein said carbon atoms are implanted with an energy level.

6. The method of claim 5, wherein said energy level can be varied to control the creation of said graphene layers.

7. The method of claim 1, wherein said first temperature is between 200 and 600° C.

8. The method of claim 1, wherein said substrate is a metal foil, selected from the group consisting of copper, nickel, iron, aluminum, bronze, brass, and invar.

9. The method of claim 1, wherein the amount of carbon atoms implanted is defined as the dose, and said dose is varied to control the creation of said graphene layers.

10. The method of claim 1, further comprising implanting hydrogen or helium atoms into said substrate, such that said hydrogen or helium atoms form bubbles beneath said carbon atoms, and cleaving said layers of graphene from said substrate.

11. A method of creating layers of graphene-based compounds, comprising:
Implanting carbon atoms into a substrate at a first temperature;
Implanting atoms of a second species into said substrate; and
Lowering the temperature of said substrate following said carbon implanting step, so that said atoms of said second species bond to said carbon atoms and said carbon and said second species diffuse from said substrate.

12. The method of claim 11, wherein said second species comprises a halogen.

13. The method of claim 11, wherein said second species comprises oxygen.

14. The method of claim 11, wherein said second species comprises hydrogen.

15. The method of claim 11, wherein said second species comprises nitrogen.

16. The method of claim 11, wherein said implanting of atoms of said carbon and said second species is performed using a plasma doping system.

17. The method of claim 11, wherein said carbon and said second species are implanted sequentially.

18. The method of claim 11, wherein said carbon and said second species are implanted simultaneously.
